(19) United States
(12) Patent Application Publication
(10) Pub. No.: US 2005/0248463 A1
(43) Pub. Date: Nov. 10, 2005

(54) System and method for monitoring timed and temperature sensitive assets during transportation

(76) Inventors: Wayne D. Williams, Spring Branch, TX (US); George R. Rakes, Powder Springs, GA (US); Richard M. Young, Marietta, GA (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 11/111,460

(22) Filed: Apr. 21, 2005

Related U.S. Application Data
(60) Provisional application No. 60/564,304, filed on Apr. 21, 2004.

(51) Int. Cl. G08B 17/00

(52) U.S. Cl. 340/584; 340/539.1

(57) ABSTRACT

The present invention provides a system that provides monitoring of timed and temperature sensitive critical assets. The system includes a transceiver means for communicating with a ground-based server, a container means for maintaining that environment for the critical asset. In addition, the system includes a communication link from the container means to the transceiver for communicating the status of the environment within the container means, and a connector means connected to the communication link and providing a removable connection to the container means. The present invention can also be viewed as a method for monitoring of timed and temperature sensitive critical assets. The method operates by establishing an onboard and an air to ground communication links. Then, the method operates by acquiring environmental conditions within a critical asset container, and transmitting the environmental conditions to a ground station.

### CROSS-REFERENCE TO RELATED APPLICATIONS

This application claims the benefit of U.S. Provisional Patent Application Ser. No. 60/564,304 filed on Apr. 21, 2004, entitled “SYSTEM AND METHOD FOR TRANSPORTING TIMED AND TEMPERATURE SENSITIVE CRITICAL ASSETS”, which is incorporated by reference herein in its entirety.

### COPYRIGHT NOTICE

A portion of the disclosure of this patent document may contain material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates to a method and system for transporting timed and temperature sensitive critical assets, and more particularly, relates to a method and system for monitoring timed and temperature sensitive assets during transportation.

### BACKGROUND OF THE INVENTION

Currently, portable refrigeration units are utilized to transport time and temperature sensitive critical assets. These time and temperature sensitive, critical assets include, but are not limited to, biohazard samples, blood and blood byproducts, organs, vaccines and the like.

The problem with transporting these critical assets is that analysis of the transport conditions must be evaluated to determine if the asset being transported was done so within the environmental requirements of the critical asset. The evaluation of the transportation environment for a critical asset is critical to determine the state of the critical asset. Currently, this evaluation can cause undue delay in the processing of the critical asset, that in and by its self can cause the critical asset to exceed its time parameters. This is because of the current systems utilized a passive monitor system that must have its environmental data downloaded upon arrival at the ultimate destination. With the sample

For example, whole human blood should be transmitted at temperatures between 30 and 37° F. An evaluation must be performed after the transportation to determine if at any time, the human blood exceeded its environmental requirements. Exceeding the environmental requirements would contaminate or render the human blood unusable for transfusion or the like. The same condition exists for other human components including organs, skin and the like.

Furthermore, biohazard material in order to be accurately evaluated must be maintained in the original environmental state in which it was discovered. If the biohazard material is not maintained in the original environmental state, it may degrade or increased its potency or disappear altogether. Therefore, it is critical that biohazard material being evaluated be maintained in the original environment.

Therefore, there is a tremendous need for an automated system to accurately determine, document, and process monitoring of time and temperature critical assets in a real-time manner.

### SUMMARY OF THE INVENTION

The present invention provides for transporting timed and temperature sensitive critical assets, and more particularly, relates to a method and system for monitoring the transportation of time and temperature critical assets.

The present invention provides a system that provides monitoring of timed and temperature sensitive critical assets. The system includes a transceiver means for communicating with a ground-based server, a container means for maintaining that environment for the critical asset. In addition, the system includes a communication link from the container means to the transceiver for communicating the status of the environment within the container means, and a connector means connected to the communication link and providing a removable connection to the container means.

The present invention can also be viewed as a method for monitoring of timed and temperature sensitive critical assets. The method operates by (1) establishing an onboard and an air to ground communication links; (2) acquiring environmental conditions within a critical asset container; and (3) transmitting the environmental conditions to a ground station.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an example of the environment for a transportation system utilizing the monitoring system of the present invention.

FIG. 2 is a block diagram illustrating an example of a monitoring system of the present invention within an aircraft, as shown in FIG. 1.

FIG. 3 is a flow chart illustrating an example of the air response process utilized in the monitoring system of the present invention, as shown in FIGS. 1 and 2.

FIG. 4 is a flow chart illustrating an example of the operation of communication function utilized in the monitoring system of the present invention, as shown in FIGS. 1, 2 and 3.

FIG. 5 is a flow chart illustrating an example of the operation of the air monitor function utilized by the monitoring system of the present invention, as shown in FIGS. 1-4.

### DETAILED DESCRIPTION OF THE PREFERRED EMBODIMENTS

The present invention relates to a system for monitoring the transportation of timed and temperature sensitive critical assets. In particular, the monitoring is provided during aircraft transportation of the time and temperature critical assets. It is the object of this invention to utilize an asset containment unit that is portable and provides the ability to maintain the critical asset in a predetermined temperature range during transport. Moreover, information regarding the critical asset is captured and provided in a real-time basis for analysis verifying the integrity of the critical asset

The monitoring system of the present invention utilizes an air to ground communications system capable of transmitting data through wireless communication including, but not limited to, satellite (i.e. Iridium), cellular, WiFiMax, SMS or other wireless bandwidth network. In the preferred embodiment, the data includes container environmental components. In other embodiments, that data may include external container environmental components, external aircraft environmental components and flight data.

This data can be in either an encrypted or unencrypted form, depending upon security requirements. This is due to the nature of the material being transported in the containment container. If the material being transported is at a level 3/level 4 biohazard or is radioactive, then the federal/state authorities and the general population would have an interest in keeping the tracking information of this hazardous flight from potential terrorist.

The data captured with regard to the critical asset is received and managed in a centralized point. This information can be populated into trip reports and transmitted to a remote the bias during and after completion of the transportation. At the end of the transportation, the data regarding the critical asset is downloaded to the centralized point for creation of a closeout report and then stored for later reference.

The centralized point is a 24-hour operation that is able to collect all transmitted information and generate client specific reports as well as provide real-time interaction to advise and correct the alarm or alerts received from the critical asset container. Any alarm or alert can be addressed by a user at the centralized point or by a person managing the critical asset container.

The data collected and stored at the centralized point is available for a reference by a remote user. The remote access can be to evaluate the validity of the state of the current critical asset or to provide analysis at a later time.

The monitoring system can also provide interactive communication to the pilot or first officer for taking action to maintain the sample in its original environment or condition.

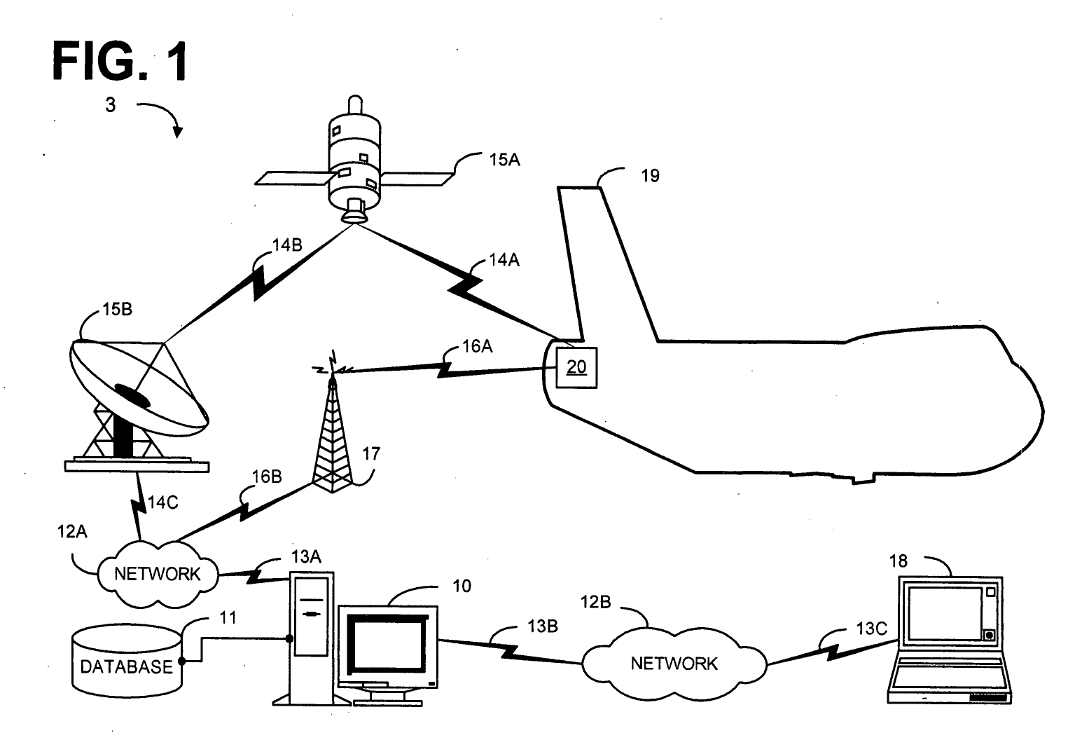

Referring now to the drawings, in which like numerals illustrate like elements throughout the several views, FIG. 1 illustrates an example of the basic components of a system 3 using the monitoring system 20 used in connection with the preferred embodiment of the present invention. The system 3 includes a server 10, monitoring system 20, remote client device 18 and communication links, 12, 13, 14, 15, 16 and 17 that utilize the monitoring system 20 of the present invention.

Server 10 contains applications, and a database 11 that can be accessed by remote client device 18 via connections 12B, 13B and 13C, respectively. The server 10 runs administrative software for a computer network and controls access to itself and database 11. Server 10 receives data from the monitoring system 20 of the present invention and stores that monitoring data in database 11.

In the preferred embodiment, the data stored in database 11 includes container environmental data that may impact the state of the critical asset. The container environmental data includes but is not limited to, temperature, humidity, pressure, acidity, radioactivity, electromagnetic field and the like. Database 11 may also store data reflecting environmental conditions on the container, as well as aircraft conditions. The environmental conditions on the container include, but are not limited to, cabin temperature, pressure, humidity, altitude, UV level, radiation level, sunlight, electromagnetic field type data and the like. Aircraft conditions include, but are not limited to, containment box serial number, flight number, the scheduled and actual takeoff and landing times of the aircraft, incidents in which the containment box was opened, if there was interruption of the power to the containment box, GPS location, airspeed, altitude, crewmembers onboard the aircraft, chain of custody data, bill of lading data, and the like. The data captured and stored it is time stamped at the time of the capture.

The monitoring system point in the present invention can communicate data regarding the critical asset utilizing a number of different communication means, including, but not limited to, satellite, cellular, WiFiMax, SMS or other wireless bandwidth network. In the preferred embodiment, the communication means a choice is utilizing a satellite communication through channels 14 communicating with satellite 15A and ground station 15B.

The remote client device 18 may access the database 11 over a network 12B and 13(C &D), such as but not limited to: the Internet, a local area network (LAN), a wide area network (WAN), via a telephone line using a modem (POTS), Bluetooth, WiFi, WiFiMax, cellular, optical, satellite, RF, Ethernet, magnetic induction, coax, RS-485 or other like networks. The server 10 may also be connected to the local area network (LAN) within an organization.

Multiple remote client devices 18 may be located at multiple remote sites. Remote client device 18 include but are not limited to, PCs, workstations, laptops, handheld computer, pocket PCs, PDAs, pagers, WAP devices, non-WAP devices, cell phones, palm devices, printing devices and the like. The remote client device 18 enables a user of the monitoring system 20 of the present invention, to receive real-time data logged for the critical asset. This enables a user to evaluate the condition of the critical asset prior to receiving the critical asset.

Thus, when a user at one of the remote client device 18 desires to access the current critical asset information from the database 11 at the server 10, the remote client device 18 communicates over the network, to access the server 10 and database 11.

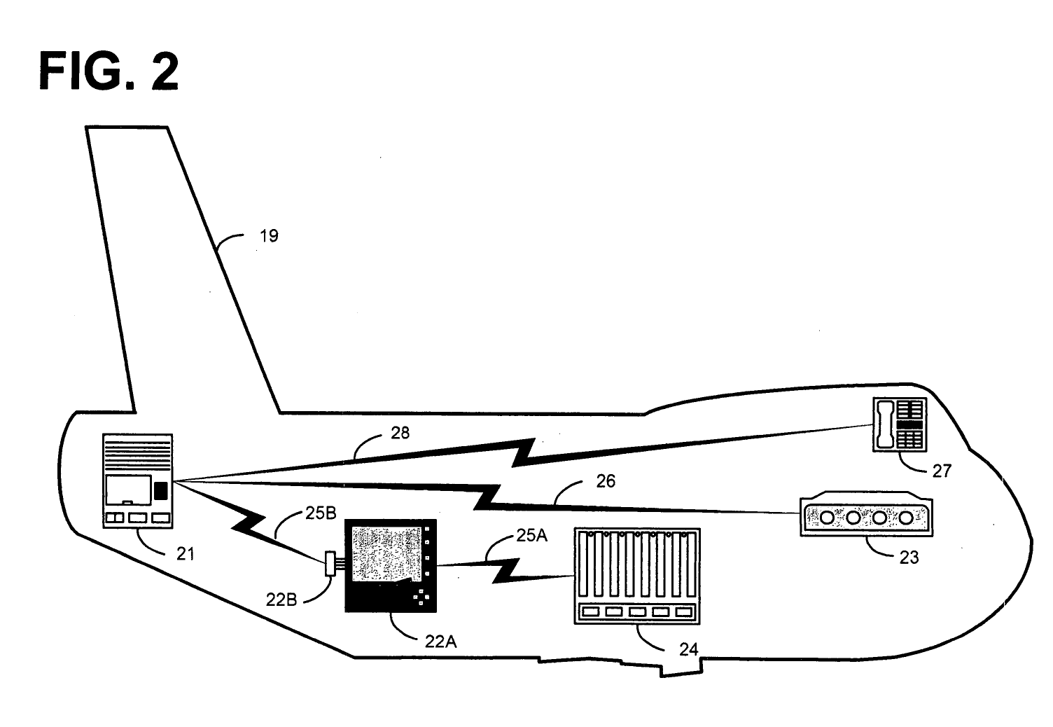

Illustrated in FIG. 2 is a block diagram illustrating an example of a monitoring system 20 of the present invention within an aircraft, as shown in FIG. 1. The monitoring system 100 of the present invention is provided to enable communication of critical asset data in a real-time environment.

As shown, there is a transceiver 21 connected to a phone 27, aircraft control panel 23, a critical asset container 24, through a controlling device 22A. Phone 27 is connected to the transceiver 21, in order to make voice communications over the communication link 14A or 16A. Aircraft control panel 23 is connected to the transceiver 21, in order to the provide aircraft parameter data. The aircraft parameter data includes but is not limited to cabin temperature, pressure, humidity, GPS location, airspeed, altitude, outside aircraft temperature, UV exposure, radiation levels, sunlight, EMS and the like.

The critical asset container 24 is utilized to maintain the critical asset's environment during the transportation event. The critical asset container 24 may be any acceptable container, including but not limited to, coolers, thermos, storage chest, incubator, portable refrigeration unit or specialized containment apparatus. In the preferred embodiment, the critical asset container 24 is provided by Logistic Health Inc. (LHI) and includes a plurality of sensors including but not limited to, temperature, humidity, pressure, acidity radioactivity, electromagnetic field and the like. The container 24 provided by LHI includes a communication path to controlling device 22A for downloading of sensors data from the critical asset container 24.

Controlling device 22A utilizes connector 22B to communicate with transceiver 21. Connector 22B may be any type of communication connector including, but not limited to, Ethernet, USB, RS-232, serial link, parallel port, fiber optic and the like. Controlling device 22A includes, but is not limited to, PCs, workstations, laptops, PDAs, palm devices and the like.

In the preferred embodiment, the transceiver 21 is Iridium satellite transceiver with a duel channel Iridium antenna. Transceiver 21 may utilize an integrated or stand-alone modem unit for digital communications such as the iridium L band transceiver, model number D1000 modem unit. Transceiver 21 is hardwired to connector 22B utilizing a serial connection. Connector 22B is hardwired and fixed in the aircraft to provide a fixed hard point connection to the removable control device 22A and container 24. It should be understood that removable control device 22A and removable container 24 can be integrated or stand-alone units as necessary.

Generally, in terms of hardware architecture, as shown in FIG. 2, the controlling device 22A includes a processor, memory, and one or more input and/or output (I/O) devices (or peripherals) that are communicatively coupled via a local interface (not shown). The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor is a hardware device for executing software that can be stored in memory. The processor can be virtually any custom made or commercially available processor, a central processing unit (CPU), data signal processor (DSP) or an auxiliary processor among several processors associated with the server computer 11, and a semiconductor based microprocessor (in the form of a microchip) or a macroprocessor. Examples of suitable commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor.

The software in memory may include one or more separate programs, each of which comprises an ordered listing of executable instructions for implementing logical functions. Software in the memory includes a suitable operating system (O/S) and the monitoring system.

A non-exhaustive list of examples of suitable commercially available operating systems is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system essentially controls the execution of other computer programs, such as the monitoring system, and provides scheduling, input-output control, file and data management, memory management, and communication control and related services. However, it is contemplated by the inventors that the monitoring system is applicable on all other commercially available operating systems.

The monitoring system may be a source program, executable program (object code), script, or any other entity comprising a set of instructions to be performed. When a source program, then the program is usually translated via a compiler, assembler, interpreter, or the like, which may or may not be included within the memory, so as to operate properly in connection with the O/S. Furthermore, the monitoring system can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts,

The I/O devices may include input devices, for example but not limited to, a keyboard, mouse, microphone (all not shown), etc. Furthermore, the I/O devices may also include output devices, for example but not limited to, a printer (not shown), display, etc. Finally, the I/O devices may further include devices that communicate both inputs and outputs, for instance but not limited to, a NIC or modulator/demodulator (for accessing remote devices, other files, devices, systems, or a network), a radio frequency (RF) or other transceiver (not shown), a telephonic interface (not shown), a bridge (not shown), a router (not shown), etc.

If the controlling device 22A is a PC, workstation, intelligent device or the like, the software in the memory may further include a basic input output system (BIOS) (omitted for simplicity). The BIOS is a set of essential software routines that initialize and test hardware at startup, start the O/S, and support the transfer of data among the hardware devices. The BIOS is stored in some type of read-only-memory, such as ROM, PROM, EPROM, EEPROM or the like, so that the BIOS can be executed when the controlling device 22A is activated.

When the controlling device 22A is in operation, the processor is configured to execute software stored within the memory, to communicate data to and from the memory, and to generally control operations of the controlling device 22A are pursuant to the software. The monitoring system and the O/S are read, in whole or in part, by the processor, perhaps buffered within the processor, and then executed.

When the monitoring system is implemented in software, it should be noted that the monitoring system can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method.

The monitoring system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the monitoring system is implemented in hardware, the monitoring system can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

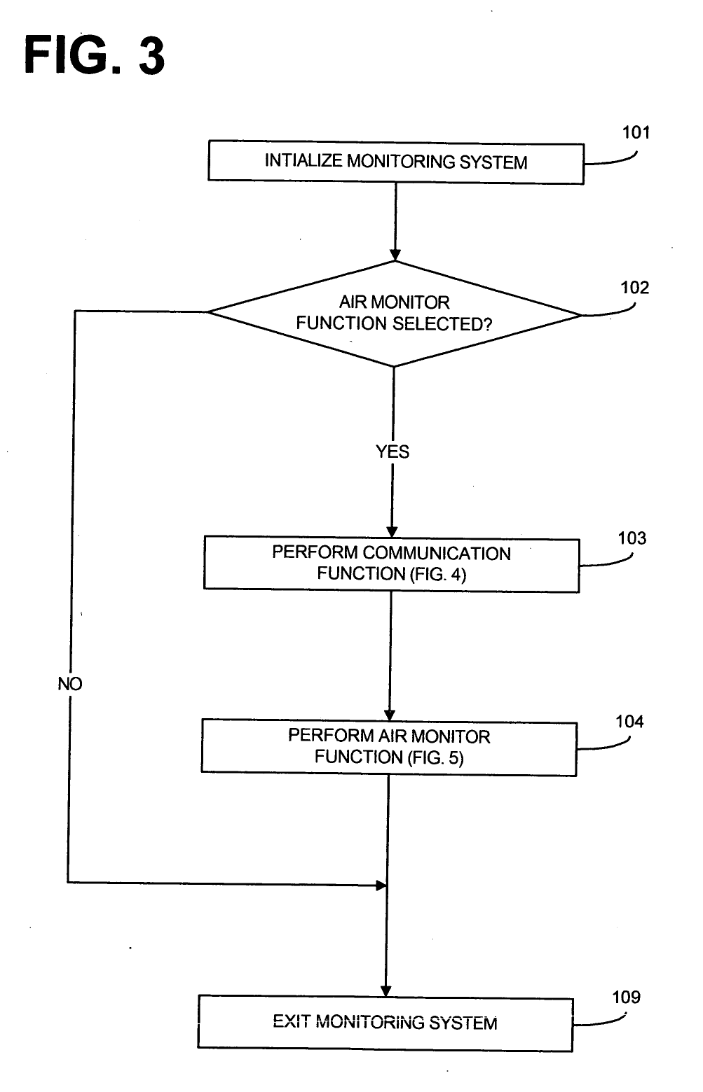

FIG. 3 is a flow chart illustrating an example of the air response process utilized in the monitoring system of the present invention, as shown in FIGS. 1 and 2. The monitoring system 100 enables the remote monitoring of critical asset data in a real-time manner.

First, the monitoring system is initialized at 101. At step 102, is determined that the air monitor function is selected. If it is determined at step 102 that the air monitoring function is not selected, then the monitoring system 100 exited at step 109.

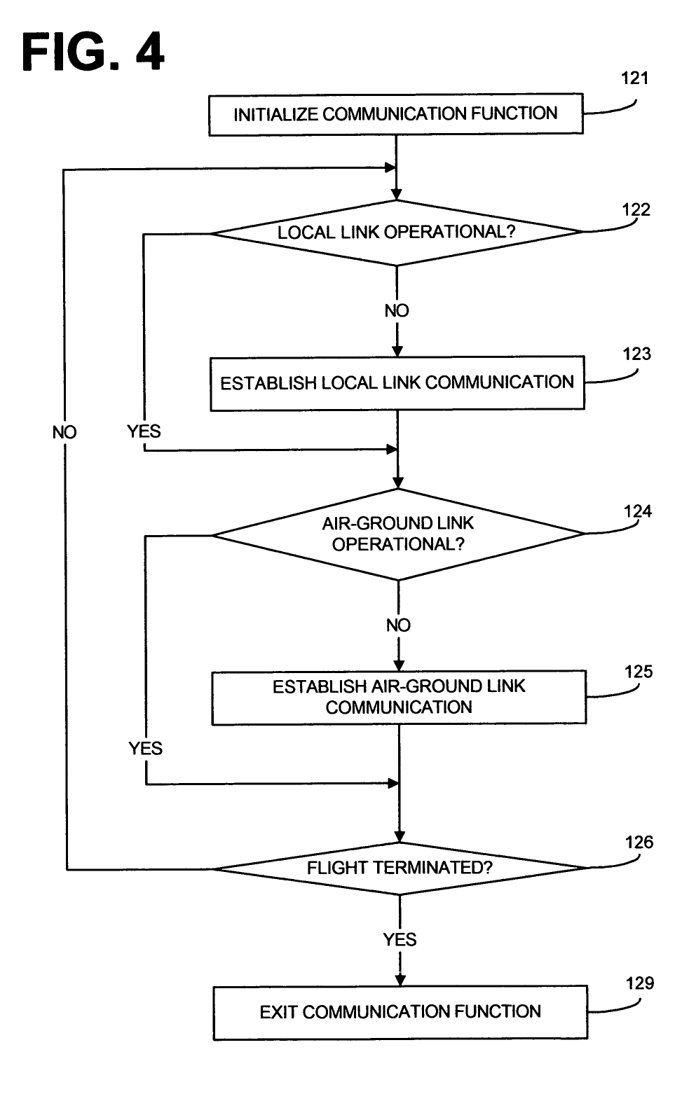

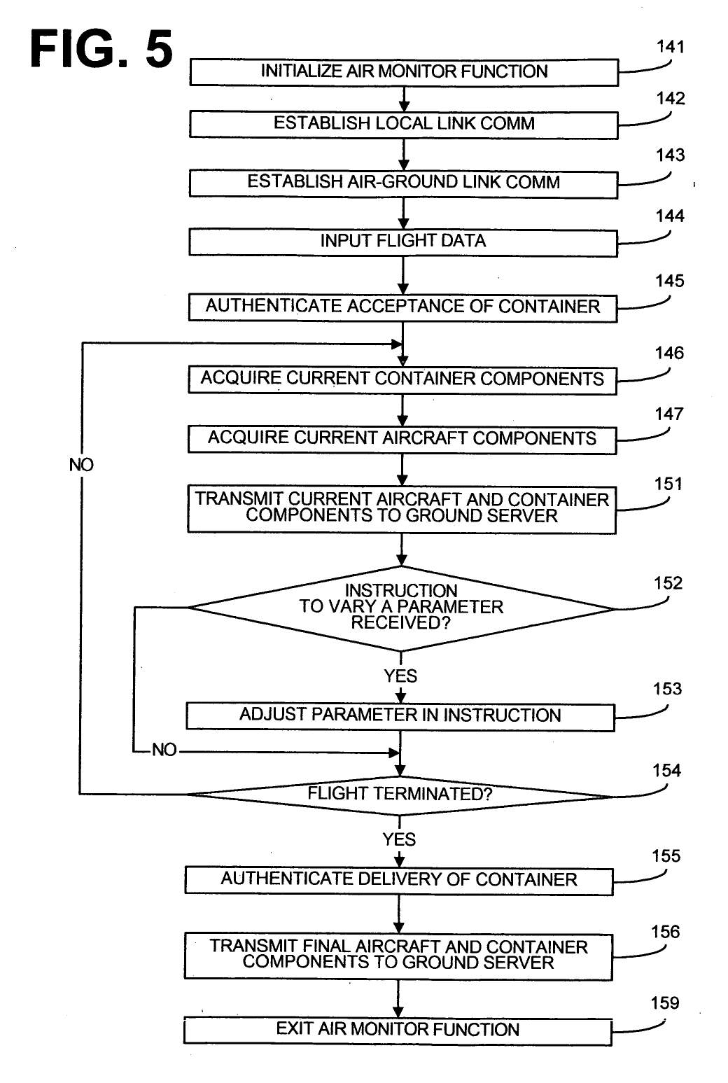

However, if it is determined at step 102 that the air monitor function is selected, then the monitoring system 100 performs the communication function at step 103. The communication function as herein described in further detail with regard to FIG. 4. Next, the monitoring system 100 performs the air monitor function at step 104. The air monitor function is herein described in further detail with regard to FIG. 5. The monitoring system 100 and exited step 109.

FIG. 4 is a flow chart illustrating an example of the operation of communication function 120 utilized in the monitoring system 100 of the present invention, as shown in FIGS. 1, 2 and 3. The communication function 120 establishes the on-aircraft and air to ground communications.

First, the communication function is initialized to step 121. At step 122, the communication function 120 determines if the local link is operational. If it is determined at step 122 that the local link is operational, then the communication function 120 skips the step 124. However, if it is determined at step 122 that the local link is not operational, then the communication function 120 establishes the local link communication at step 123.

At step 124, the communication function 120 determines that the air to ground link is operational. If it is determined at step 124 that the air to ground link is operational, then the communication function 120 skips the step 126. However, if it is determined at step 124 that the air to ground link is not operational, then the communication function 120 establishes the air to ground link communication at step 125.

At step 126, the communication function 120 determines if the flight is terminated. If it is determined that the flight is not terminated at step 126, the communication function 120 returns to repeat steps 122 through 126. However, if it is determined at step 126 that the flight is terminated, then the communication function 120 then exits step 129.

FIG. 5 is a flow chart illustrating an example of the operation of the air monitoring function 140 utilized by the monitoring system 100 of the present invention, as shown in FIGS. 1-4. The air monitoring function 140 provides the real-time monitoring of critical asset data.

At step 141, the air monitor function is initialized. As step 142, the air monitoring function 140 establishes of the local link communication. At step 143, the air monitor function 140 establishes the air to ground link communication. The communication established in the steps 142 and 143 are the actual communication protocols established by controlling device 22A with transceiver 21 and container 24.

The flight data is then input into controlling device 22A at step 144. The flight data includes, but is not limited to the containment box serial number, flight number, the scheduled and actual takeoff and landing times of the aircraft, crewmembers onboard the aircraft, chain of custody data, bill of lading data, and the like. At step 145, the air monitor function 140 then authenticates the acceptance of the container. This authentication of the acceptance of the container process is performed by the pilot or first officer.

At step 146, the air monitor function 140 acquires the current container component data and timestamps the data entries. The container component data includes, but is not limited to, temperature, humidity, pressure, acidity, radioactivity, electromagnetic field, whether the container was opened and the like.

At step 147, the air monitor function 140 then acquires the current aircraft components and timestamps the data entries. The aircraft components include, but are not limited to, cabin temperature, pressure, humidity, altitude, GPS location, airspeed, altitude, UV level, radiation level, sunlight, electromagnetic field type data and the like.

At step 151, the air monitor function 140 transmits the current aircraft in container component data to the ground server 10. This transmission is performed utilizing the communication links 25(A&B) and transceiver 21. In the preferred embodiment, the communication between container 24, controlling device 22A and transceiver 21 utilizes a hard wired communication links 25(A&B). These communication links 25(A&B) include, but are not limited to, Ethernet, USB, RS-232, serial link, parallel port, fiber optical and the like.

At step 152, the air monitor function 140 determines if an instruction to very a parameter is received. If it is determined at step 152 that an instruction was not received, then the air monitor function 140 precedes the step 154. However, if it is determined at step 152 that an instruction to very a parameter was received, and then the adjustment of the parameter is perform as instructed at step 153. This adjustment would be performed by the pilot or first officer.

At step 154, the air monitor function then determines if the flight is terminated. If it is determined at step 154 that the flight is not terminated, then the air monitor function 140 returns to repeat steps 146 through 154. However, if it is determined at step 154 that the flight is terminated, then the air monitor function 140 performs the authentication and delivery of the container at step 155. The data would be input into controlling device 22A for validation and authentication by the pilot or first officer.

At step 156, the air monitor function 140 transmits the final aircraft in container components to the ground server 10. At step 159, the air monitor function 140 exits.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

1. A system that provides monitoring of timed and temperature sensitive critical asset on an airplane, comprising:
a transceiver means for communicating with a ground-based server;
a container means for maintaining that environment for the critical asset;
a communication link from the container means to the transceiver for communicating the status of the environment within the container means; and
a connector means connected to the communication link and providing a removable connection to the container means.

2. The system of claim 1, further comprising:
a modem connected to the transceiver means for translating digital data from the container to the transceiver for transmission.

3. The system of claim 1, wherein the container means of further comprises:
a plurality of sensors.

4. The system of claim 3, wherein the plurality of sensors further comprises:
a temperature sensor.

5. The system of claim 3, wherein the plurality of sensors further comprises:
a humidity sensor.

6. The system of claim 3, wherein the plurality of sensors further comprises:
a pressure sensor.

7. The system of claim 3, wherein the plurality of sensors further comprises:
a loss of container integrity sensor.

8. The system of claim 1, wherein the transceiver means further comprises:
a cellular transceiver.

9. The system of claim 1, wherein the transceiver means further comprises:
an Iradium satellite transceiver.

10. A method for monitoring of timed and temperature sensitive critical assets, during transport, comprising:
establishing an onboard communications link;
establishing an air to ground communication link; and
acquiring environmental conditions within a critical asset container; and
transmitting the environmental conditions to a ground station.

11. The method of claim 10, further comprising the step of:
acquiring a temperature level with in the critical asset container.

12. The method of claim 10, further comprising the step of:
acquiring a humidity level with in the critical asset container.

13. The method of claim 10, further comprising the step of:
acquiring a pressure level with in the critical asset container.

14. The method of claim 10, further comprising the step of:
acquiring a container integrity reading for the critical asset container.

15. The method of claim 10, further comprising the step of:
determining if an environmental parameter being maintained by the critical assets container needs to be changed; and
performing the parameter adjustment as instructed.

16. The method of claim 10, further comprising the step of:
electronically documenting the acceptance of the critical asset container on board.

17. The method of claim 16, further comprising the step of:
electronically documenting the delivery of the critical assets container to the final destination.

18. The method of claim 10, further comprising the step of:
transmitting final critical asset container environmental conditions to the ground server.

19. The method of claim 10, further comprising the step of:
transmitting final aircraft environmental conditions to the ground server.

20. The method of claim 10, further comprising the step of:
acquiring aircraft environmental conditions.
